(19) United States
(12) Patent Application Publication
(10) Pub. No.: US 2009/0053467 A1
(43) Pub. Date: Feb. 26, 2009

(54) Pressure-Sensitive Adhesive Sheet

(75) Inventors: Kiichiro Kato, Saitama (JP); Tadahiro Tomino, Saitama (JP); Tomomi Suzuki, Saitama (JP)

Correspondence Address: POSZ LAW GROUP, PLC, 12040 SOUTH LAKES DRIVE, SUITE 101, RESTON, VA, 20191, US

(73) Assignee: LINTEC CORPORATION, Tokyo (JP)

(21) Appl. No.: 11/988,548

(22) PCT Filed: Jul. 20, 2006
(86) PCT No.: PCT/JP2006/314828

§ 371 Date: Mar. 11, 2008

(30) Foreign Application Priority Data
Jul. 20, 2005 (JP) 2005-210465
Apr. 3, 2006 (JP) 2006-101385

(51) Int. Cl. B32B 3/24

(52) U.S. Cl. 428/138

(57) ABSTRACT

In a pressure-sensitive adhesive sheet 1 that comprises a base material 11 and a pressure-sensitive adhesive layer 12, and has formed therein by thermal processing a plurality of through holes 2 passing through one surface to the other surface of the pressure-sensitive adhesive sheet 1, as the base material 11, one is used for which, upon heating at a heating rate of 20° C./min under a nitrogen atmosphere, the temperature at a thermal decomposition peak where the mass reduction is greatest is not more than 450° C., or the difference between the temperature at the thermal decomposition peak and the temperature at a melting peak is not more than 250° C. According to this pressure-sensitive adhesive sheet 1, the appearance of the pressure-sensitive adhesive sheet 1 is not marred by the through holes 2 formed by the thermal processing.

### TECHNICAL FIELD

The present invention relates to a pressure-sensitive adhesive sheet according to which air entrapment and blistering can be prevented or eliminated.

### BACKGROUND ART

When sticking a pressure-sensitive adhesive sheet onto an adherend by hand, entrapment of air between the adherend and the pressure-sensitive adhesive surface may occur, marring the appearance of the pressure-sensitive adhesive sheet. Such air entrapment is particularly prone to occur in the case that the pressure-sensitive adhesive sheet has a large area.

Moreover, a resin material such as an acrylic resin, an ABS resin, a polystyrene resin or a polycarbonate resin may emit a gas upon heating or even with no heating; in the case of sticking a pressure-sensitive adhesive sheet onto an adherend made of such a resin material, blistering may occur on the pressure-sensitive adhesive sheet due to the gas emitted from the adherend.

To solve such problems, in International Patent Application Laid-open No. 2004/061031, there is proposed a pressure-sensitive adhesive sheet in which through holes of diameter 0.1 to 300 μm are formed at a hole density of 30 to 50,000 per 100 cm². According to this pressure-sensitive adhesive sheet, air or gas on the pressure-sensitive adhesive surface side can escape from the through holes to the pressure-sensitive adhesive sheet surface side, and hence air entrapment or blistering of the pressure-sensitive adhesive sheet can be prevented.

### DISCLOSURE OF THE INVENTION

### Problem to be Solved by the Invention

In the above pressure-sensitive adhesive sheet, the through holes may be formed using laser hole-forming processing. Among laser hole-forming processing methods, carbon dioxide laser processing is so-called laser thermal processing as opposed to ablation processing, being a method in which the processing is carried out through a process in which material is decomposed by heat. In the case that the base material is made of an olefinic material, the internal diameter of the through holes may be enlarged through such a thermal processing method. If the internal diameter of the through holes is enlarged in this way, then the appearance of the pressure-sensitive adhesive sheet may deteriorate due to the periphery of the opening of each of the through holes caving in, and in the case that liquid such as water or gasoline becomes attached to the pressure-sensitive adhesive sheet obtained after the pressure-sensitive adhesive sheet has been stuck onto an adherend, this liquid may enter into the through holes, causing the through hole portions (parts around the periphery of the through holes) to swell or the like so that the appearance of the pressure-sensitive adhesive sheet is marred.

The present invention has been devised in view of the above state of affairs; it is an object of the present invention to provide a pressure-sensitive adhesive sheet in which through holes are formed by thermal processing, according to which air entrapment and blistering can be prevented or eliminated, and there is no marring of the appearance of the pressure-sensitive adhesive sheet.

### Means for Solving the Problem

To attain the above object, firstly, the present invention provides a pressure-sensitive adhesive sheet comprising a base material and a pressure-sensitive adhesive layer, the pressure-sensitive adhesive sheet having formed therein, by thermal processing, a plurality of through holes passing through one surface to the other surface of the pressure-sensitive adhesive sheet, the pressure-sensitive adhesive sheet characterized in that: upon heating the base material at a heating rate of 20° C./min under a nitrogen atmosphere, the temperature at a thermal decomposition peak where the mass reduction is greatest is not more than 450° C. (invention 1).

Secondly, the present invention provides a pressure-sensitive adhesive sheet comprising a base material and a pressure-sensitive adhesive layer, the pressure-sensitive adhesive sheet having formed therein, by thermal processing, a plurality of through holes passing through one surface to the other surface of the pressure-sensitive adhesive sheet, the pressure-sensitive adhesive sheet characterized in that: upon heating the base material at a heating rate of 20° C./min under a nitrogen atmosphere, the difference between the temperature at a thermal decomposition peak where the mass reduction is greatest and the temperature at a melting peak is not more than 250° C. (invention 2).

Thirdly, the present invention provides a pressure-sensitive adhesive sheet comprising a base material and a pressure-sensitive adhesive layer, the pressure-sensitive adhesive sheet having formed therein, by thermal processing, a plurality of through holes passing through one surface to the other surface of the pressure-sensitive adhesive sheet, the pressure-sensitive adhesive sheet characterized in that: upon heating the base material at a heating rate of 20° C./min under a nitrogen atmosphere, the temperature at a thermal decomposition peak where the mass reduction is greatest is not more than 450° C., and in the case that there is a melting peak, the difference between the temperature at the thermal decomposition peak and the temperature at the melting peak is not more than 250° C. (invention 3).

Note that in the present specification, “sheet” is deemed to include the idea of a film, and “film” is deemed to include the idea of a sheet.

For a base material satisfying conditions as above, when the through holes are formed by the thermal processing, there is little thermal damage, and hence the internal diameter of the through holes is not enlarged. That is, according to the above inventions (inventions 1 to 3), deterioration in the appearance of the pressure-sensitive adhesive sheet due to enlargement of the internal diameter of the through holes is prevented.

In the case of the above inventions (inventions 1 to 3), the thermal processing is preferably laser thermal processing (invention 4). Moreover, in the case of the above invention (invention 4), the laser used in the laser thermal processing is preferably a carbon dioxide laser (invention 5).

In the case of the above inventions (inventions 1 to 5), the diameter of the through holes at the surface of the base material is preferably less than the diameter of the through holes at the pressure-sensitive adhesive surface of the pressure-sensitive adhesive layer (invention 6). Through the diameter of the through holes changing in this way, the through holes become yet less conspicuous at the base material surface, and hence the appearance of the pressure-sensitive adhesive sheet becomes yet better.

### Effects of the Invention

According to the present invention, a pressure-sensitive adhesive sheet is obtained in which through holes are formed by thermal processing, according to which air entrapment and blistering can be prevented or eliminated, and there is no marring of the appearance of the pressure-sensitive adhesive sheet.

### BRIEF DESCRIPTION OF THE DRAWINGS

FIG. 1 is a sectional view of a pressure-sensitive adhesive sheet according to an embodiment of the present invention;

FIG. 2 is an enlarged sectional view of part of the pressure-sensitive adhesive sheet showing a through hole with an enlarged internal diameter;

FIG. 3 consists of sectional views showing an example of a method of manufacturing the pressure-sensitive adhesive sheet according to an embodiment of the present invention;

FIG. 4 is a graph showing TG/DTA simultaneous measurement results for a base material of Example 1;

FIG. 5 is a graph showing TG/DTA simultaneous measurement results for a base material of Example 2;

FIG. 6 is a graph showing TG/DTA simultaneous measurement results for a base material of Example 3;

FIG. 7 is a graph showing TG/DTA simultaneous measurement results for a base material of Example 4;

FIG. 8 is a graph showing TG/DTA simultaneous measurement results for a base material of Example 5;

FIG. 9 is a graph showing TG/DTA simultaneous measurement results for a base material of Example 6; and

FIG. 10 is a graph showing TG/DTA simultaneous measurement results for base materials of Comparative Examples 1 and 2.

### EXPLANATION OF REFERENCE NUMERALS

1: Pressure-sensitive adhesive sheet
11: Base material
12: Pressure-sensitive adhesive layer
13: Release liner
1A: Base material surface
1B: Pressure-sensitive adhesive surface
2: Through hole

### BEST MODE FOR CARRYING OUT THE INVENTION

Following is a description of an embodiment of the present invention.

### [Pressure-Sensitive Adhesive Sheet]

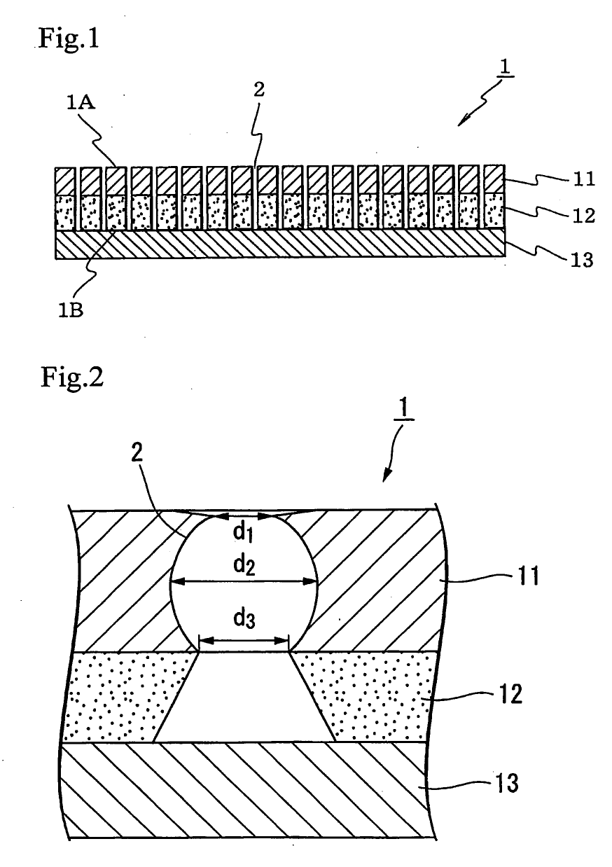

FIG. 1 is a sectional view of a pressure-sensitive adhesive sheet according to an embodiment of the present invention.

As shown in FIG. 1, the pressure-sensitive adhesive sheet 1 according to the present embodiment comprises a base material 11, a pressure-sensitive adhesive layer 12, and a release liner 13 laminated on one another. Note, however, that the release liner 13 is peeled off when using the pressure-sensitive adhesive sheet 1.

A plurality of through holes 2 that penetrate through the base material 11 and the pressure-sensitive adhesive layer 12 and thus pass from a base material surface 1A to a pressure-sensitive adhesive surface 1B are formed in the pressure-sensitive adhesive sheet 1. When the pressure-sensitive adhesive sheet 1 is used, air between the adherend and the pressure-sensitive adhesive surface 1B of the pressure-sensitive adhesive layer 12 and gas emitted from an adherend escape from these through holes 2 to the outside of the base material surface 1A, and hence as described later, air entrapment and blistering can be prevented or eliminated.

Upon heating at a heating rate of 20° C./min under a nitrogen atmosphere, the base material 11 must satisfy one of the following:

(a) the temperature at a thermal decomposition peak where the mass reduction is greatest is not more than 450° C.;
(b) the difference between the temperature at the thermal decomposition peak where the mass reduction is greatest and the temperature at a melting peak is not more than 250° C.; or
(c) the temperature at the thermal decomposition peak where the mass reduction is greatest is not more than 450° C., and in the case that there is a melting peak, the difference between the temperature at the thermal decomposition peak and the temperature at the melting peak is not more than 250° C.

For the base material 11, through the thermal decomposition temperature being low and/or the difference between the thermal decomposition temperature and the melting temperature being small as described above, when the through holes 2 are formed by thermal processing, particularly laser thermal processing, more particularly carbon dioxide laser processing, there is little thermal damage to the base material 11, and hence the internal diameter of the through holes 2 is not enlarged. Problems caused by enlargement of the internal diameter of the through holes 2, i.e. problems such as the appearance of the pressure-sensitive adhesive sheet 1 deteriorating due to the periphery of the opening of each of the through holes 2 caving in, and in the case that liquid such as water or gasoline becomes attached to the pressure-sensitive adhesive sheet 1 obtained after the pressure-sensitive adhesive sheet 1 has been stuck onto an adherend, this liquid entering into the through holes 2, causing the through hole portions (parts around the periphery of the through holes) to swell or the like so that the appearance of the pressure-sensitive adhesive sheet 1 is marred, thus do not occur.

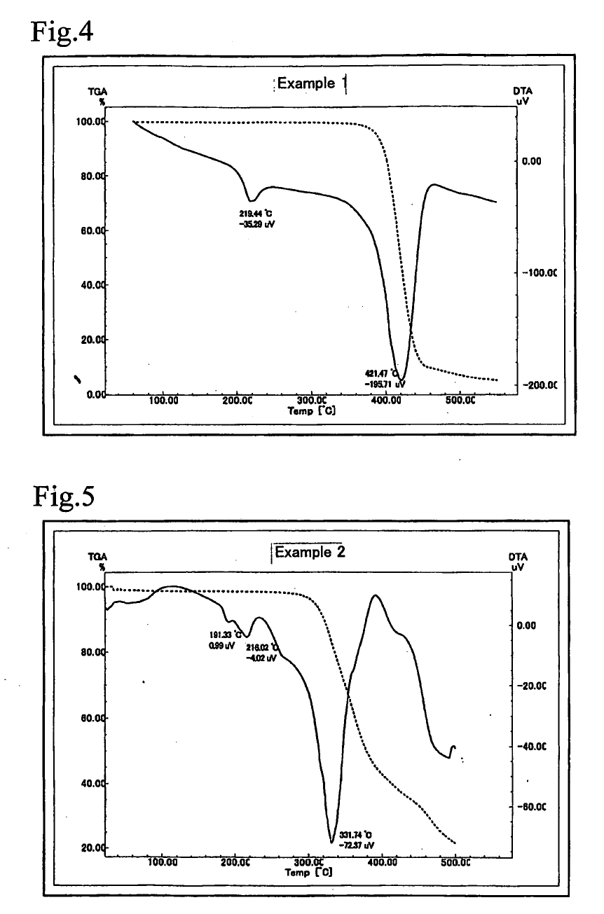

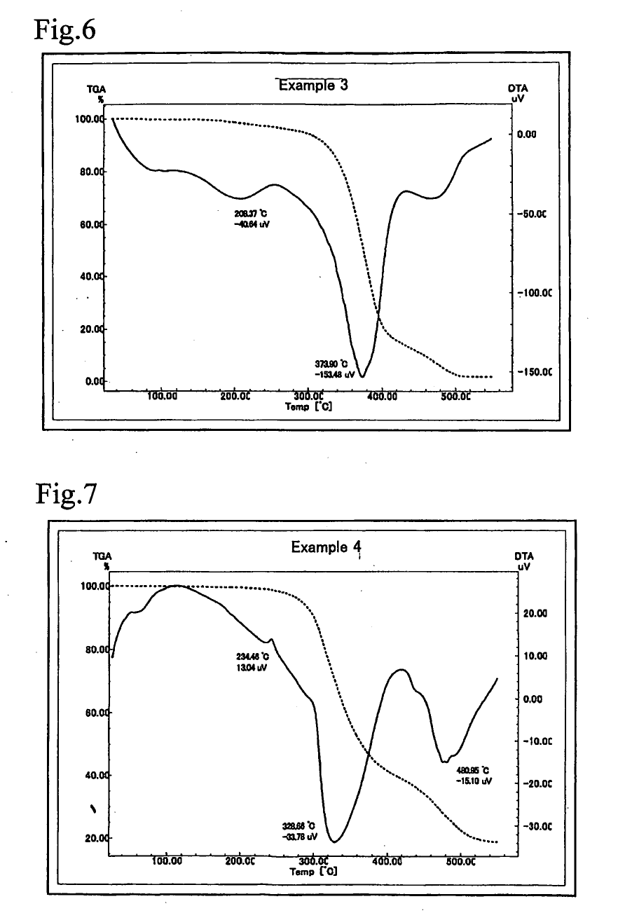

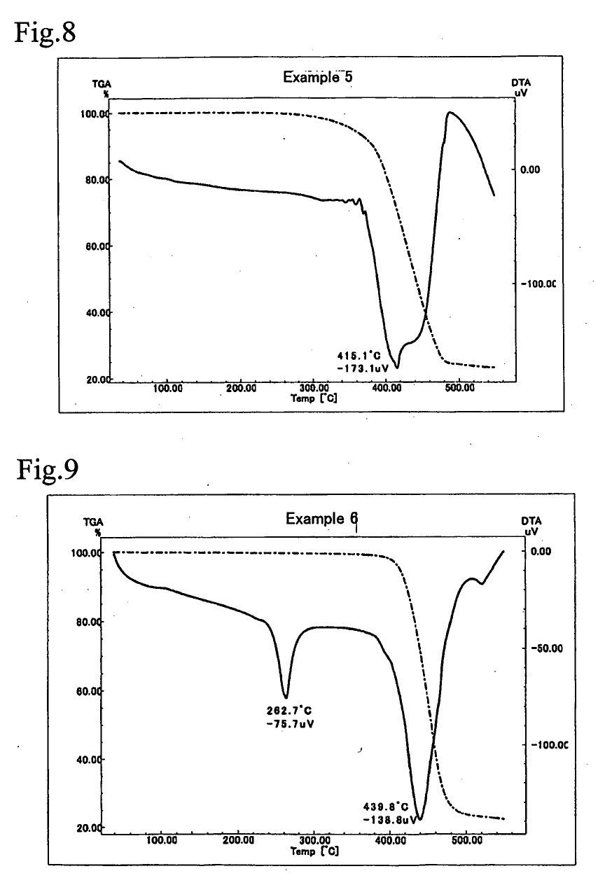

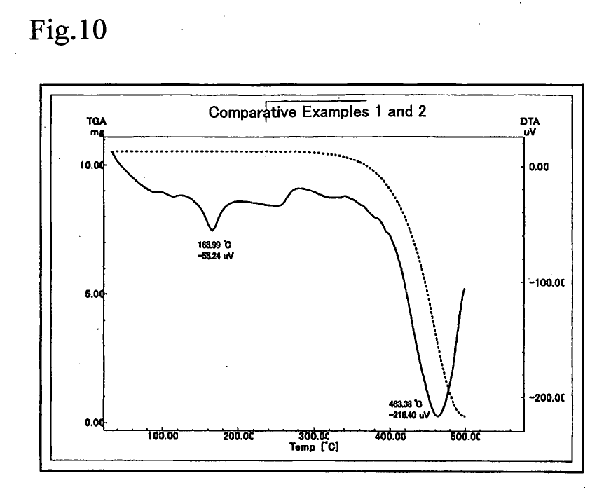

Note that the stipulation “where the mass reduction is greatest” is intended to specify the temperature corresponding to the largest thermal decomposition peak in the case that there are a plurality of thermal decomposition peaks (see FIGS. 4 to 10). Moreover, in the case that there are a plurality of melting peaks, the melting peak at the lowest temperature is used. This is because melting first starts at the temperature of this melting peak.

Here, enlargement of the internal diameter of the through holes 2 basically means that, as shown in FIG. 2, the maximum diameter d₂ of a through hole 2 in the base material 11 is greater than the diameter d₁ of the through hole 2 at the base material surface 1A, and moreover is markedly greater than the diameter d₃ of the through hole 2 at the interface between the base material 11 and the pressure-sensitive adhesive layer 12, but is not necessarily limited to corresponding to such conditions, with any change in the diameter of the through holes 2 that produces problems as described above being deemed to be included. If the internal diameter of a through hole 2 is enlarged, then in accordance with the diameter d₂ of the through hole 2, the periphery of the opening of the through hole 2 tends to cave in (see FIG. 2).

The above temperature of the base material 11 at the thermal decomposition peak is preferably 300 to 440° C., and the above difference between the temperature at the thermal decomposition peak and the temperature at the melting peak is preferably not more than 235° C.

As the material of the base material 11, one having thermal decomposition characteristics as described above is preferably selected from publicly known materials; an example of such a material is a film or foamed film made of a resin such as a polyester, a polyester type thermoplastic elastomer, a polyurethane, a polyurethane type thermoplastic elastomer, polystyrene, a polystyrene type thermoplastic elastomer, any of various modified, for example epoxidated, thermoplastic elastomers, polyvinyl chloride, an acrylic polymer, an acrylic-urethane copolymer, an acrylic-urethane graft copolymer, or an acrylic urethane such as a blend of an acrylic resin and a urethane resin, or a laminated film of the above, or a resin film such as synthetic paper. On the other hand, for a resin film made of a polyolefin such as polyethylene or polypropylene, or a polyolefin type thermoplastic elastomer, the thermal decomposition temperature is high and the melting temperature is low, and hence upon irradiating with a laser beam, the material melts before undergoing thermal decomposition and dispersing, and hence the internal diameter of the through holes is enlarged.

As the material of the base material 11, of the above resin films, from an environmental viewpoint, a resin film made of a polymer not containing chlorine atoms in the skeleton thereof, specifically a resin film made of a polyester, a polyester type thermoplastic elastomer, a polyurethane, a polyurethane type thermoplastic elastomer, polystyrene, a polystyrene type thermoplastic elastomer, any of various modified, for example epoxidated, thermoplastic elastomers, an acrylic polymer, an acrylic-urethane copolymer, an acrylic-urethane graft copolymer, or an acrylic urethane such as a blend of an acrylic resin and a urethane resin is more preferable.

Moreover, as the material of the base material 11, of the above resin films, a resin film having a modulus of elasticity in tension (Young's modulus) of 100 to 2500 MPa, specifically of resin films made of polybutylene terephthalate, a polyester type thermoplastic elastomer, a polyurethane, a polyurethane type thermoplastic elastomer, polystyrene, a polystyrene type thermoplastic elastomer, any of various modified, for example epoxidated, thermoplastic elastomers, polyvinyl chloride, an acrylic polymer, an acrylic-urethane copolymer, an acrylic-urethane graft copolymer, or an acrylic urethane such as a blend of an acrylic resin and a urethane resin, one having a modulus of elasticity in tension within the above range is preferable. A resin film having a modulus of elasticity in tension of at least 100 MPa is easy to handle, and a resin film having a modulus of elasticity in tension of not more than 2500 MPa has a high ability to follow a curved surface and is thus suitable for use on an adherend having a curved surface.

That is, as the material of the base material 11, a resin film made of polybutylene terephthalate, a polyester type thermoplastic elastomer, a polyurethane, a polyurethane type thermoplastic elastomer, polystyrene, a polystyrene type thermoplastic elastomer, any of various modified, for example epoxidated, thermoplastic elastomers, an acrylic polymer, an acrylic-urethane copolymer, an acrylic-urethane graft copolymer, or an acrylic urethane such as a blend of an acrylic resin and a urethane resin is particularly preferable.

Note that the above resin film may contain any of various additives such as inorganic fillers, organic fillers, and ultraviolet absorbers. Moreover, the resin film may be one formed by a casting method or the like using a process material. Furthermore, so long as there is no adverse effect on the shape of the through holes 2, the surface of the resin film may have a decorative layer formed thereon by a method such as printing, painting, transfer from a transfer sheet, vapor deposition, or sputtering, or may have formed thereon an adhesion facilitating coat for forming such a decorative layer, or a coating layer such as a gloss adjusting coat, or may have formed thereon a coating layer such as a hard coat, a contamination preventing coat, a surface roughness/specular gloss adjusting coat, or a coat for conferring weather resistance. Moreover, such a decorative layer or coating layer may be formed over the whole of the material, or may be formed on only part of the material.

The thickness of the base material 11 is generally approximately 1 to 500 μm, preferably 3 to 300 μm, but may be changed as appropriate in accordance with the use of the pressure-sensitive adhesive sheet 1.

There are no particular limitations on the type of the pressure-sensitive adhesive constituting the pressure-sensitive adhesive layer 12 so long as this pressure-sensitive adhesive is one in which the through holes 2 can be formed; the pressure-sensitive adhesive may be any of an acrylic type, a polyester type, a polyurethane type, a rubber type, a silicone type, or the like. Moreover, the pressure-sensitive adhesive may be any of an emulsion type, a solvent type, or a solvent-less type, and may be either a crosslinked type or a non-crosslinked type.

The thickness of the pressure-sensitive adhesive layer 12 is generally 1 to 300 μm, preferably 5 to 100 μm, but may be changed as appropriate in accordance with the use of the pressure-sensitive adhesive sheet 1.

There are no particular limitations on the material of the release liner 13; for example, a film or foamed film made of a resin such as polyethylene terephthalate, polypropylene or polyethylene, or paper such as glassine, coated paper or laminated paper that has been subjected to release treatment with a release agent such as a silicone type one, a fluorine type one or a long chain alkyl group-containing carbamate can be used.

The thickness of the release liner 13 is generally approximately 10 to 250 μm, preferably approximately 20 to 200 μm. Moreover, the thickness of the release agent in the release liner 13 is generally 0.05 to 5 μm, preferably 0.1 to 3 μm.

The through holes 2 that penetrate through the base material 11 and the pressure-sensitive adhesive layer 12 are formed by thermal processing, described below.

The diameter of the through holes 2 in the base material 11 and the pressure-sensitive adhesive layer 12 is preferably 0.1 to 300 μm, particularly preferably 0.5 to 150 μm. Through the diameter of the through holes 2 satisfying these conditions, air or gas can readily escape from the through holes 2, but moreover the through holes 2 can not be readily seen with the naked eye on the base material surface 1A, and hence the pressure-sensitive adhesive sheet 1 will have an excellent appearance.

The diameter of the through holes 2 may be constant in the thickness direction of the pressure-sensitive adhesive sheet 1, or may change in the thickness direction of the pressure-sensitive adhesive sheet 1, but in the case that the diameter of the through holes 2 changes in the thickness direction of the pressure-sensitive adhesive sheet 1, the diameter of the through holes 2 preferably decreases gradually from the pressure-sensitive adhesive sheet rear surface 1B to the pressure-sensitive adhesive sheet front surface 1A. Through the diameter of the through holes 2 changing in this way, the through holes 2 become yet less conspicuous at the pressure-sensitive adhesive sheet front surface 1A, and hence the appearance of the pressure-sensitive adhesive sheet 1 becomes yet better.

The hole density of the through holes 2 is preferably 30 to 50,000 per 100 cm², particularly preferably 100 to 10,000 per 100 cm². If the hole density of the through holes 2 is less than 30 per 100 cm², then it may be difficult for air gas to escape, whereas if the hole density of the through holes 2 is greater than 50,000 per 100 cm², then the mechanical strength of the pressure-sensitive adhesive sheet 1 may drop.

The through holes 2 in the pressure-sensitive adhesive sheet 1 according to the present embodiment penetrate through only the base material 11 and the pressure-sensitive adhesive layer 12, but the through holes 2 may also penetrate through the release liner 13.

Moreover, the pressure-sensitive adhesive sheet 1 according to the present embodiment has the release liner 13, but there is no limitation to this in the present invention; the pressure-sensitive adhesive sheet 1 may have no release liner 13. Furthermore, there are no particular limitations on the size, shape and so on of the pressure-sensitive adhesive sheet 1 according to the present embodiment. For example, the pressure-sensitive adhesive sheet 1 may be a tape comprising only the base material 11 and the pressure-sensitive adhesive layer 12 (a pressure-sensitive adhesive tape), and may also be wound up into a roll.

### [Manufacture of Pressure-Sensitive Adhesive Sheet]

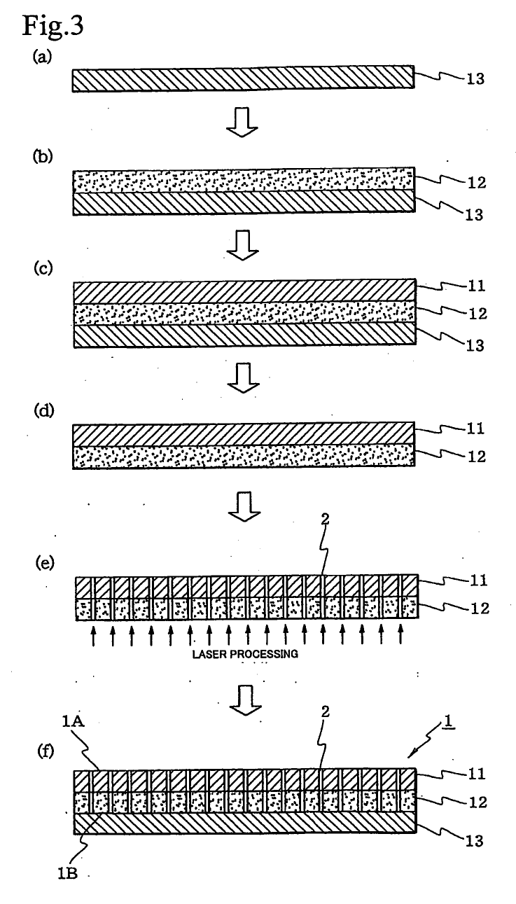

An example of a method of manufacturing the pressure-sensitive adhesive sheet 1 according to the above embodiment will now be described with reference to FIGS. 3(a) to (f).

In the present manufacturing method, firstly, as shown in FIGS. 3(a) and (b), the pressure-sensitive adhesive layer 12 is formed on the release treated surface of the release liner 13. The pressure-sensitive adhesive layer 12 may be formed by preparing a coating agent containing the pressure-sensitive adhesive that will constitute the pressure-sensitive adhesive layer 12, and also a solvent if desired, applying the coating agent onto the release treated surface of the release liner 13 using a coater such as a roll coater, a knife coater, a roll knife coater, an air knife coater, a die coater, a bar coater, a gravure coater, or a curtain coater, and drying.

Next, as shown in FIG. 3(c), the base material 11 superposed onto the surface of the pressure-sensitive adhesive layer 12, thus obtaining a laminate comprising the base material 11, the pressure-sensitive adhesive layer 12, and the release liner 13. Then, as shown in FIG. 3(d), the release liner 13 is peeled off from the pressure-sensitive adhesive layer 12, then, as shown in FIG. 3(e), the through holes 2 are formed in the laminate comprising the base material 11 and the pressure-sensitive adhesive layer 12, and then, as shown in FIG. 3(f), the release liner 13 is superposed again onto the pressure-sensitive adhesive layer 12.

The formation of the through holes 2 is carried out by thermal processing. As types of such thermal processing, there are laser thermal processing, hot needles, fusing perforation, and so on, but of these, laser thermal processing is preferable since minute through holes with good air escaping ability can easily be formed at a desired hole density. Examples of the type of laser used in the laser thermal processing include a carbon dioxide (CO₂) laser, a TEA-CO₂ laser, a YAG laser, a UV-YAG laser, a YVO₄ laser, and a YLF laser, but of these a carbon dioxide laser is preferable from the perspective of production efficiency, cost, and so on.

For the laser hole-forming processing, there are burst processing (a burst mode) in which one place is irradiated continuously with the laser beam until one through hole 2 is formed, and cyclic processing (a cyclic mode) in which a plurality of places are irradiated sequentially with the laser beam so as to form a plurality of through holes 2 uniformly. The former is superior in terms of thermal efficiency, and the latter is superior in that the effect of heat on the article being processed can be reduced. The laser thermal processing may be carried out using either of these modes.

When carrying out the laser thermal processing, it is preferable to irradiate the pressure-sensitive adhesive layer 12 with the laser beam directly from the pressure-sensitive adhesive layer 12 side. By carrying out the laser thermal processing from the pressure-sensitive adhesive layer 12 side in this way, even if the through holes 2 become tapered, the diameter of the through holes 2 can be made to be smaller on the base material 11 side than the pressure-sensitive adhesive layer 12 side. Moreover, by temporarily peeling off the release liner 13 and irradiating the pressure-sensitive adhesive layer 12 with the laser beam directly, there is no widening of the opening of each of the through holes 2 in the pressure-sensitive adhesive layer 12 due to thermally melted matter from the release liner 13, and hence the degree of precision of the diameter and the hole density will be high, and thus through holes 2 can be formed that will not be prone to being entered by water or the like which might have an adverse effect on the pressure-sensitive adhesive sheet 1. Furthermore, when irradiating the pressure-sensitive adhesive layer 12 with the laser beam, by making the release liner 13 be not present therebetween, the laser beam irradiation time can be shortened, or the laser output energy can be reduced. If the laser output energy is reduced, then adverse effects on the pressure-sensitive adhesive layer 12 and the base material 11 will be reduced, and it will be possible to form through holes 2 of uniform shape with little melted matter (dross) and few thermally deformed parts caused by heat from the laser beam.

In the case of using as the base material 11 one formed by a casting method or the like using a process material, the laser thermal processing may be carried out in a state with this process material laminated onto the surface of the base material 11. Moreover, before carrying out the laser thermal processing, a peelable protective sheet may be laminated onto the surface of the base material (on which a process material has not been laminated) 11 at a desired stage. As the protective sheet, for example a publicly known protective sheet comprising a base material comprising a publicly known resin film or the like having a removable pressure-sensitive adhesive layer laminated thereon can be used.

In the case of forming the through holes 2 by laser thermal processing, melted matter may become attached around the openings of the through holes 2, but through the process material or protective sheet being present on the surface of the base material 11, the melted matter will become attached to the process material or the protective sheet rather than the base material 11, and hence the appearance of the pressure-sensitive adhesive sheet 1 can be better maintained.

Note that in the above manufacturing method, the pressure-sensitive adhesive layer 12 was formed on the release liner 13, and then the base material 11 was superposed onto the formed pressure-sensitive adhesive layer 12, but there is no limitation to this in the present invention, for example the pressure-sensitive adhesive layer 12 may be formed on the base material 11 directly. Moreover, the laser thermal processing may be carried out in a state with the release liner 13 laminated on, and furthermore the irradiation with the laser beam may be carried out from the base material 11 side.

### [Use of Pressure-Sensitive Adhesive Sheet]

When sticking the pressure-sensitive adhesive sheet 1 onto an adherend, firstly the release liner 13 is peeled off from the pressure-sensitive adhesive layer 12.

Next, the pressure-sensitive adhesive surface 1B of the exposed pressure-sensitive adhesive layer 12 is made to be in close contact with the adherend, and then the pressure-sensitive adhesive sheet 1 is pressed onto the adherend. At this time, air between the adherend and the pressure-sensitive adhesive surface 1B of the pressure-sensitive adhesive layer 12 escapes from the through holes 2 formed in the pressure-sensitive adhesive sheet 1 to the outside of the base material surface 1A, and hence air tends not to be caught up between the adherend and the pressure-sensitive adhesive surface 1B, i.e. air entrapment is prevented from occurring. Even if air is caught up so that air entrapment occurs, by re-pressing the air-entrapped portion or an air-entrapped portion surrounding portion including the air-entrapped portion, the air can be made to escape from the through holes 2 to the outside of the base material surface 1A, thus eliminating the air entrapment. Such elimination of air entrapment is possible even after a long time has elapsed after the sticking on of the pressure-sensitive adhesive sheet 1.

Moreover, even if gas is emitted from the adherend after the pressure-sensitive adhesive sheet 1 has been stuck onto the adherend, this gas will escape from the through holes 2 formed in the pressure-sensitive adhesive sheet 1 to the outside of the base material surface 1A, whereby the pressure-sensitive adhesive sheet 1 is prevented from blistering.

According to the above pressure-sensitive adhesive sheet 1, there is no enlargement of the internal diameter of the through holes 2, and hence there is no deterioration of the appearance of the pressure-sensitive adhesive sheet 1 due to the periphery of the opening of each of the through holes 2 caving in, and moreover even in the case that liquid such as water or gasoline becomes attached to the pressure-sensitive adhesive sheet 1 obtained after the pressure-sensitive adhesive sheet 1 has been stuck onto an adherend, this liquid will not enter into the through holes 2 and hence there will be no swelling of the through hole portions (parts around the periphery of the through holes), and thus a good appearance of the pressure-sensitive adhesive sheet 1 can be maintained.

### EXAMPLES

Following is a more detailed description of the present invention through examples and so on; however, the scope of the present invention is not limited by these examples and so on.

### Example 1

An acrylic solvent type pressure-sensitive adhesive (made by Lintec Corporation, PK) coating agent was applied using a knife coater such that the thickness after drying would be 30 μm onto the release treated surface of a release liner (made by Lintec Corporation, FPM-11, thickness: 175 μm) obtained by laminating both surfaces of woodfree paper with a polyethylene resin and subjecting one surface to release treatment with a silicone type release agent, and drying was carried out for 1 minute at 90° C. A resin film made of a polyester type thermoplastic elastomer (made by Kurabo Industries Ltd., ES9300BK, thickness: 100 μm) as a base material was superposed onto the pressure-sensitive adhesive layer thus formed, and a protective sheet having a removable pressure-sensitive adhesive layer (made by Sumiron Co., Ltd., E-2035, thickness: 60 μm) was stuck on to the surface of the base material, where by a laminate having a four-layer structure was obtained.

The release liner was peeled off from the laminate, and the laminate was irradiated with a carbon dioxide laser (made by Matsushita Industrial Equipment Co., Ltd.; using YB-HCSO3, two-shot burst processing, frequency: 3000 Hz, pulse width: 50 μ sec (first shot)/40 μsec (second shot)) from the pressure-sensitive adhesive layer side, thus forming through holes at a hole density of 2500 per 100 cm². The release liner was then superposed again onto the pressure-sensitive adhesive layer, and the protective sheet was peeled off from the base material surface, whereby a pressure-sensitive adhesive sheet was obtained.

### Example 2

A pressure-sensitive adhesive sheet was manufactured as in Example 1, except that a resin film made of a blend of an acrylic resin and a urethane resin (made by Nippon Carbide Industries Co., Inc., B(41)C-M, thickness: 100 μm) was used as the base material, and the carbon dioxide laser second shot pulse width was made to be 20 μsec.

### Example 3

A pressure-sensitive adhesive sheet was manufactured as in Example 1, except that a resin film made of a polyurethane (made by Seikoh Chemicals Co., Ltd., FT80-100BK, thickness: 100 μm) was used as the base material, and the carbon dioxide laser second shot pulse width was made to be 20 μsec.

### Example 4

A pressure-sensitive adhesive sheet was manufactured as in Example 1, except that a resin film made of polyvinyl chloride (made by Nippon Carbide Industries Co., Inc., Fuji-Paint 83448M2(30), thickness: 100 μm) was used as the base material, and the carbon dioxide laser second shot pulse width was made to be 50 μsec.

### Example 5

A pressure-sensitive adhesive sheet was manufactured as in Example 1, except that a two-type three-layer laminated resin film comprising an acrylic resin layer (thickness: 16 μm), a styrene type thermoplastic elastomer layer (thickness: 68 μm), and an acrylic resin layer (thickness: 16 μm) (made by Gunze Ltd., VM-52, thickness: 100 μm) was used as the base material, and the carbon dioxide laser second shot pulse width was made to be 50 μsec, and a third shot pulse width 20 μsec.

### Example 6

A pressure-sensitive adhesive sheet was manufactured as in Example 1, except that a resin film made of a polyester (made by Toyobo Co., Ltd., Crisper G2311, thickness: 50 μm) was used as the base material, and the carbon dioxide laser first shot pulse width was made to be 25 μsec, and the second shot pulse width 20 μsec.

### Comparative Example 1

A pressure-sensitive adhesive sheet was manufactured as in Example 1, except that a resin film made of a polyolefin type thermoplastic elastomer (made by Mitsubishi Chemical MKV Company, CT-030, thickness: 100 μm) was used as the base material, and the number of shots for the carbon dioxide laser was made to be four (pulse width for first to third shots: 50 μsec, pulse width for fourth shot: 40 μsec).

Note that when a laminate manufactured as in Example 1 except that the base material was made to be the above resin film made of a polyolefin type thermoplastic elastomer was irradiated with a carbon dioxide laser under the same conditions as in Example 1, through holes were not formed.

### Comparative Example 2

A pressure-sensitive adhesive sheet was manufactured as in Example 1, except that a resin film made of a polyolefin type thermoplastic elastomer (made by Mitsubishi Chemical MKV Company, CT-030, thickness: 100 μm) was used as the base material, and the number of shots for the carbon dioxide laser was made to be six (pulse width for first to fifth shots: 30 μsec, pulse width for sixth shot: 20 μsec).

Note that when a laminate manufactured as in Example 1 except that the base material was made to be the above resin film made of a polyolefin type thermoplastic elastomer was irradiated with a carbon dioxide laser under the same conditions as in Example 1, through holes were not formed.

### Test Examples

### (1) Differential Thermal/Thermogravimetric Simultaneous Measurement

For each of the base materials used in the Examples and Comparative Examples (sample weight: 10 mg), TG/DTA simultaneous measurement (differential thermal/thermogravimetric simultaneous measurement) was carried out under the following conditions. The DTA (differential thermal analysis) was carried out in accordance with JIS K7121, and the TG (thermogravimetry) was carried out in accordance with JIS K7120.

Measurement apparatus: DTG-60 differential thermal/thermogravimetric simultaneous measurement apparatus, made by Shimadzu Corporation

### Atmosphere: N₂

N₂ purging condition: 50 ml/min
Heating rate: 20° C./min

Graphs showing the measurement results are shown in FIGS. 4 to 10. In each graph, the full line shows the DTA, and the dotted line shows the TGA. The temperature at a melting peak (T₁), the temperature at a thermal decomposition peak (T₂), the difference between the temperature at the thermal decomposition peak and the temperature at the melting peak (T₂−T₁), and the percentage weight reduction over 40 to 500° C. were determined from each of the graphs. The results are shown in Table 1.

TABLE 1

| | Percentage | | Temperature T₂ | |
|---|---|---|---|---|
| | weight | Temperature T₁ | at thermal | |
| | reduction | at melting | decomposition | T₂ − T₁ |
| | (%) | peak (° C.) | peak (° C.) | (° C.) |
| Example 1 | 93.14 | 219.4 | 421.5 | 202.1 |
| Example 2 | 77.27 | 191.3 | 331.7 | 140.4 |
| Example 3 | 97.44 | — | 373.9 | — |
| Example 4 | 77.50 | — | 328.7 | — |
| Example 5 | 75.82 | — | 415.2 | — |
| Example 6 | 76.32 | 262.7 | 439.8 | 177.1 |
| Comparative | 97.59 | 166.0 | 463.4 | 297.4 |
| Example 1 | | | | |
| Comparative | 97.59 | 166.0 | 463.4 | 297.4 |
| Example 2 | | | | |

### (2) Through Hole Diameter Measurement

Each of the pressure-sensitive adhesive sheets obtained in the Examples and Comparative Examples was cut at a through hole portion, and the diameter of a through hole at the base material surface, the maximum diameter within the base material, the diameter at the interface between the base material and the pressure-sensitive adhesive layer, and the diameter at the pressure-sensitive adhesive surface were measured using a scanning electron microscope (made by Hitachi Ltd., model S-2360N). The results are shown in Table 2.

### (3) Appearance Inspection

For each of the pressure-sensitive adhesive sheets obtained in the Examples and Comparative Examples, an appearance inspection was carried out as follows. The results are shown in Table 2.

The pressure-sensitive adhesive sheet (size: 30 mm×30 mm) from which the release liner had been peeled off was stuck onto a white melamine coated plate, and the appearance of the surface of the pressure-sensitive adhesive sheet was inspected with the naked eye under indoor fluorescent lighting. The distance from the eyes to the pressure-sensitive adhesive sheet was made to be approximately 30 cm, and the angle from which the pressure-sensitive adhesive sheet was viewed was varied. Pressure-sensitive adhesive sheets for which the result was that the appearance was not marred by the through holes were marked as “O”, and ones for which the appearance was marred by the through holes were marked as “x”. Next, each pressure-sensitive adhesive sheet which had been stuck onto a melamine coated plate and left for 24 hours was immersed for 168 hours in warm water at 40° C. or for 0.5 hours in gasoline at room temperature, and was then picked up therefrom, and after 48 hours it was judged by visual inspection whether the appearance of the pressure-sensitive adhesive sheet was unmarred by swelling or the like of the through hole portions. Comparing with before immersion, pressure-sensitive adhesive sheets for which the through holes were not conspicuous were marked as “O”, and ones for which the through holes became conspicuous were marked as “x”.

TABLE 2

| | Diameter of through holes (μm) | | | | | | |
|---|---|---|---|---|---|---|---|
| | | Maximum | | Pressure- | Appearance | | |
| | Base | diameter | | sensitive | Immediately | After immersion | |
| | material | within base | | adhesive | after being | Warm | |
| | surface | material | Interface | surface | stuck on | water | Gasoline |
| Example 1 | 30 | 60 | 60 | 65 | ◯ | ◯ | ◯ |
| Example 2 | 30 | 65 | 65 | 70 | ◯ | ◯ | ◯ |
| Example 3 | 20 | 50 | 55 | 60 | ◯ | ◯ | ◯ |
| Example 4 | 25 | 60 | 60 | 70 | ◯ | ◯ | ◯ |
| Example 5 | 25 | 65 | 65 | 70 | ◯ | ◯ | (*1) |
| Example 6 | 30 | 55 | 55 | 60 | ◯ | ◯ | ◯ |
| Comparative | 30 | 140 | 70 | 180 | X | X | X |
| Example 1 | | | | | | | |
| Comparative | 25 | 100 | 50 | 140 | X | X | X |
| Example 2 | | | | | | | |

(*1): Resin of base material itself not gasoline-resistant

### (4) Air Entrapment Removability Test 1

For each of the pressure-sensitive adhesive sheets obtained in the Examples and Comparative Examples, an air entrapment removability test was carried out as follows. The results are shown in Table 3.

The pressure-sensitive adhesive sheet (size: 50 mm×50 mm) from which the release liner had been peeled off was stuck onto a flat melamine coated plate such that air entrapment occurred with a diameter of approximately 15 mm, and then the pressure-sensitive adhesive sheet was pressed on using a squeegee, and it was verified whether or not the air entrapment could be eliminated. Pressure-sensitive adhesive sheets for which the result was that the air entrapment was eliminated were marked as “O”, and ones for which the air entrapment was not eliminated (including ones for which even a small amount of air entrapment remained) were marked as “x”.

### (5) Air Entrapment Removability Test 2

For each of the pressure-sensitive adhesive sheets obtained in the Examples and Comparative Examples, an air entrapment removability test was carried out as follows. The results are shown in Table 3.

The pressure-sensitive adhesive sheet (size: 50 mm×50 mm) from which the release liner had been peeled off was stuck onto a 70 mm×70 mm melamine coated plate having therein a depression (recess) having the shape of part of a spherical surface with a diameter of 15 mm and a maximum depth of 1 mm (there was air entrapment between the depression and the pressure-sensitive adhesive sheet), and then the pressure-sensitive adhesive sheet was pressed on using a squeegee, and it was verified whether or not the air entrapment could be eliminated. Pressure-sensitive adhesive sheets for which the result was that the pressure-sensitive adhesive sheet followed the recess in the melamine coated plate and hence the air entrapment was eliminated were marked as “O”, and ones for which the pressure-sensitive adhesive sheet did not follow the recess in the melamine coated plate and hence the air entrapment was not eliminated (including ones for which even a small amount of air entrapment remained) were marked as “x”.

### (6) Measurement of Modulus of Elasticity in Tension (Young's Modulus)

Each of the pressure-sensitive adhesive sheets obtained in the Examples and Comparative Examples was cut to a width of 15 mm and a length of 150 mm, the release liner was peeled off, and then the pressure-sensitive adhesive sheet was attached to a tensile strength tester (Tensilon, made by Orientec Co., Ltd.) with a grip spacing of 100 mm, and was stretched at 200 mm/min, and the modulus of elasticity in tension (Young's modulus) was calculated in accordance with JIS K7161 and JIS K7127. The results are shown in Table 3.

TABLE 3

| | | | Modulus of |
|---|---|---|---|
| | | | elasticity in |
| | | | tension |
| | Air entrapment | Air entrapment | (Young's modulus) |
| | removability 1 | removability 2 | (MPa) |
| Example 1 | ◯ | ◯ | 358 |
| Example 2 | ◯ | ◯ | 432 |
| Example 3 | ◯ | ◯ | 184 |
| Example 4 | ◯ | ◯ | 750 |
| Example 5 | ◯ | ◯ | 619 |
| Example 6 | ◯ | (*2) | 2900 |
| Comparative | ◯ | ◯ | 450 |
| Example 1 | | | |
| Comparative | ◯ | ◯ | 450 |
| Example 2 | | | |

(*2): No ability to follow depression in melamine coated plate

As can be seen from Tables 1 to 3, for the pressure-sensitive adhesive sheets using a base material conforming to the conditions of the present invention (Examples 1 to 6), the air escaping ability was excellent, and moreover there was no enlargement of the internal diameter of the through holes, and hence the appearance was good both initially and after immersing in warm water or gasoline (with the exception of Example 5), and furthermore the ability to follow a curved surface was also excellent (with the exception of Example 6).

### INDUSTRIAL APPLICABILITY

The pressure-sensitive adhesive sheet of the present invention can be favorably used in the case that air entrapment or blistering would be generally prone to occur with a pressure-sensitive adhesive sheet, for example in the case that the pressure-sensitive adhesive sheet has a large area, or the case that gas is emitted from the adherend, and in the case that a good appearance is required not only under an ordinary environment but also under an environment in which a liquid such as water or gasoline becomes attached to the pressure-sensitive adhesive sheet.

1. A pressure-sensitive adhesive sheet comprising a base material and a pressure-sensitive adhesive layer, the pressure-sensitive adhesive sheet having formed therein, by thermal processing, a plurality of through holes passing through one surface to the other surface of the pressure-sensitive adhesive sheet, the pressure-sensitive adhesive sheet characterized in that:
upon heating said base material at a heating rate of 20° C./min under a nitrogen atmosphere, the temperature at a thermal decomposition peak where the mass reduction is greatest is not more than 450° C.

2. A pressure-sensitive adhesive sheet comprising a base material and a pressure-sensitive adhesive layer, the pressure-sensitive adhesive sheet having formed therein, by thermal processing, a plurality of through holes passing through one surface to the other surface of the pressure-sensitive adhesive sheet, the pressure-sensitive adhesive sheet characterized in that:
upon heating said base material at a heating rate of 20° C./min under a nitrogen atmosphere, the difference between the temperature at a thermal decomposition peak where the mass reduction is greatest and the temperature at a melting peak is not more than 250° C.

3. A pressure-sensitive adhesive sheet comprising a base material and a pressure-sensitive adhesive layer, the pressure-sensitive adhesive sheet having formed therein, by thermal processing, a plurality of through holes passing through one surface to the other surface of the pressure-sensitive adhesive sheet, the pressure-sensitive adhesive sheet characterized in that:
upon heating said base material at a heating rate of 20° C./min under a nitrogen atmosphere, the temperature at a thermal decomposition peak where the mass reduction is greatest is not more than 450° C., and in the case that there is a melting peak, the difference between the temperature at the thermal decomposition peak and the temperature at the melting peak is not more than 250° C.

4. The pressure-sensitive adhesive sheet according to claim 1, characterized in that said thermal processing is laser thermal processing.

5. The pressure-sensitive adhesive sheet according to claim 4, characterized in that a laser used in said laser thermal processing is a carbon dioxide laser.

6. The pressure-sensitive adhesive sheet according to claim 1, characterized in that the diameter of said through holes at a surface of said base material is less than a diameter of said through holes at a pressure-sensitive adhesive surface of said pressure-sensitive adhesive layer.

7. The pressure-sensitive adhesive sheet according to claim 2, characterized in that said thermal processing is laser thermal processing.

8. The pressure-sensitive adhesive sheet according to claim 3, characterized in that said thermal processing is laser thermal processing.

9. The pressure-sensitive adhesive sheet according to claim 7, characterized in that a laser used in said laser thermal processing is a carbon dioxide laser.

10. The pressure-sensitive adhesive sheet according to claim 8, characterized in that a laser used in said laser thermal processing is a carbon dioxide laser.

11. The pressure-sensitive adhesive sheet according claim 2, characterized in that the diameter of said through holes at a surface of said base material is less than a diameter of said through holes at a pressure-sensitive adhesive surface of said pressure-sensitive adhesive layer.

12. The pressure-sensitive adhesive sheet according claim 3, characterized in that the diameter of said through holes at a surface of said base material is less than a diameter of said through holes at a pressure-sensitive adhesive surface of said pressure-sensitive adhesive layer.

13. The pressure-sensitive adhesive sheet according claim 4, characterized in that the diameter of said through holes at a surface of said base material is less than a diameter of said through holes at a pressure-sensitive adhesive surface of said pressure-sensitive adhesive layer.

14. The pressure-sensitive adhesive sheet according claim 5, characterized in that the diameter of said through holes at a surface of said base material is less than a diameter of said through holes at a pressure-sensitive adhesive surface of said pressure-sensitive adhesive layer.
